(19) United States
(12) Patent Application Publication
(10) Pub. No.: US 2004/0186771 A1
(43) Pub. Date: Sep. 23, 2004

(54) System and method for internet advertising through on-line games

(76) Inventor: Stuart Squires, Mission (CA)

Correspondence Address: Paul Smith Intellectual Property Law, 330-1508 West Broadway, Vancouver, BC, V6JIW8, CA

(21) Appl. No.: 10/478,235

(22) PCT Filed: May 24, 2002
(86) PCT No.: PCT/CA02/00768

(30) Foreign Application Priority Data
Jun. 12, 2001 (CA) 2350224

(51) Int. Cl. G06F 17/60

(52) U.S. Cl. 705/14

(57) ABSTRACT

The present invention is a system and method for Internet advertising through the use of an Internet based triva game.

### FIELD OF THE INVENTION

This invention relates to the field of Internet advertising. More specifically, it deals with the use of an Internet based trivia game in order to target the game sponsors' Internet advertising to specific audiences on the Internet. In order to be successful at the game, participants must visit and study the web sites of the sponsors of the game.

### BACKGROUND OF THE INVENTION

Computer use, both in the home and in business, has increased substantially over the past years. Along with the increase in computer use there has been a corresponding increase in the use of the Internet. The Internet has opened up incredible opportunities for the accumulation and dissemination of information. Information from around the world is available to any user with a computer and access to the Internet.

Businesses have adapted to the times and are using the Internet to sell their respective goods and services. Advertising on the Internet has therefore increased substantially. Typically, Internet advertising has come in the form of Internet banner advertisements. The advertiser places its Internet banner advertisement on a popular homepage. The banner contains a link to the advertiser's homepage, so that when a user clicks on the banner their browser is directed to the advertiser's web site.

There are many deficiencies associated with Internet banner advertisements. For example, it is difficult to condense an advertisement into the small space allowed for a banner advertisement on any given homepage. Furthermore, the placement of a banner ad on a homepage takes space and detracts from the homepage. There is also no limit to the number of banners on a web page, so banner advertisers must compete against one another. Most importantly, however, the placement of a banner advertisement does not ensure that a user will in fact view the advertisement or that the user will visit the advertiser's web site.

Considerable effort has been made to overcome these deficiencies. However, these efforts have centered on further developing the Internet advertising itself. For example, Canadian Patent No. 2307950 teaches a system whereby a users movement within a browser is monitored such that once no mouse or keyboard activity has taken place for a predetermined period of time, a larger, or full page advertisement is displayed.

While a larger advertisement displayed only at times of non-activity overcomes prior problems with space, it too has its deficiencies. It requires a period of inactivity by the user in order to be displayed, otherwise no advertising occurs. Because it is displayed at times of non-activity, it fails to ensure that a user will in fact view the advertisement or that the user will visit the advertiser's web site.

A further problem exists with respect to the targeting of Internet advertising to a specific segment of the population. While advertisers' are able to select the homepages upon which their banner advertisement's are displayed, they remain limited in their ability to target specific segments of the population.

Methods have been developed to overcome this deficiency by combining games played over a network with product advertising. For example, U.S. Pat. No. 5,823,879 teaches a method for combining on-line casino-type games with real-time product advertising. Game players play automated games such as blackjack, poker, and craps while information related to advertised items is exchanged between players and advertisers. Advertising is selectively provided to a specific desired demographic by comparing player personal information. However, these types of ads placed over the Internet are disruptive and displeasing to a user wishing to focus on the games and not marketing ploys.

U.S. Pat. No. 6,036,601 teaches a method for advertising within the virtual environment of games without interrupting the game play. Advertisers are able to reach a specific demographic by matching ads to the demographic data of the game player. Default images within the virtual world of the game are replaced with virtual pictures and figures utilizing an advertisement. While this method overcomes the problem of game disruption, it does not provide certainty that the advertisement will be viewed, as typical on-line gamers play with a furious intensity and may not notice the advertisement located within the virtual environment of the game. Furthermore, the advertisements are directed solely to the limited demographic playing the on-line game.

U.S. Pat. No. 6,102,406 teaches Internet advertising using a scavenger hunt metaphor. Advertisers pay to form part of a scavenger hunt. The scavenger hunts can be tailored to appeal to specific demographics. Participants in the scavenger hunt are provided with questions along with clues suggesting where information may be located with which to answer the questions. The participant must determine the relevant web site to visit from the clue. Once the participant provides the correct answer and verification is received that the participant visited the respective sponsors' web site in which the information to correctly answer the question was located, the participant is provided with the next question. By requiring verification that the participant visited the sponsor web site, the sponsor is provided with an accurate account of traffic to its site as a result of the scavenger hunt. The participant reaches the end of the scavenger hunt when the participant correctly answers all the questions. All participants that successfully complete a scavenger hunt are eligible to win prizes associated with that scavenger hunt. Prizes are awarded based on random draws from all eligible participants.

U.S. Pat. No. 6,102,406 addresses several problems such as ensuring that Internet advertising is targeted to specific demographics and is actually viewed, however, deficiencies remain. By requiring the participant to decipher clues in order to determine the sponsor web site to visit in order to answer a question, it is possible that many participants will never visit the sponsor web sites. In addition, it remains possible for participants to cheat on a scavenger hunt. For example, a participant that has completed the scavenger hunt could help a friend to navigate through all the correct web sites and provide correct answers without that friend ever actually viewing the information contained on the respective sponsor web sites. Furthermore, a competitive environment is not created as participants that correctly answer all the questions are placed in a random draw for prizes with all the other participants that correctly answered all the questions. As a result, participants have less incentive to complete the scavenger hunt, as successful completion of the scavenger hunt only gives them a chance of winning prizes. In addition, since the participant already knows the question that needs to be answered when they review the sponsor web site they need only scan the site for the answer rather than learning all information available on the site. Finally, while grouping together the advertisers of products and services that appeal to a specific demographic increases the probability that the advertisers will reach their desired demographic, it does not ensure this will be the case. Participants are able to select whichever scavenger hunt they wish to take part in regardless of their demographic.

It is therefore an object of the present invention to provide a method of targeting advertising to specific segments of the population and to provide incentive to a user to view the advertiser's web site. It is a further object of the invention to provide a system wherein the users direct more in depth attention to the advertiser's web site.

### SUMMARY OF THE INVENTION

The present invention is a system and method for Internet advertising through the use of an Internet based trivia game.

In one aspect, the invention comprises a real-time trivia game in which at least one sponsor pays to provide questions about its products and/or services. A plurality of users use a plurality of remote game terminals to compete simultaneously in the trivia game in order to win prizes by answering a plurality of questions using information about the products and/or services of the sponsors obtained prior to commencement of the game using a list of game sponsors provided a pre-determined time before the commencement.

In another aspect, the invention comprises a method of controlling an Internet-based trivia game comprises designating at least one sponsor of the game; authorizing a plurality of users to participate in the game; prior to commencement of the game, identifying the sponsor to the users and enabling the users to link to information about the sponsor's products and/or services; at the commencement of the game, communicating to the users questions based on the information about the sponsor's products and/or services; and designating a winner among the users of the game based on the correctness of, and the time to provide, the answers provided by each of the users.

Another method of hosting an Internet game-based advertising system according to the invention comprises receiving a communication from said sponsor; uniquely identifying said sponsor; collecting and storing information about said sponsor; allowing said sponsor to sponsor a game upon payment of an entry fee by the sponsor; accepting from said sponsor questions and answers relating to said sponsor's products and/or services for use in said trivia game; receiving a communication from each of said users; uniquely identifying each of said users; collecting and storing information about each of said users; allowing said users to participate in said trivia game; prior to said trivia game, identifying said sponsor to said users and enabling said users to link to information about said sponsor's products and/or services; at the commencement of said game, communicating to said users questions based on said information about said sponsor's products and/or services; and designating a winner of said game based on the correctness of and the time to provide, the answers provided by the users.

A method of sponsoring an Internet game-based advertising system according to the invention comprises communicating with said central server by way of a sponsor terminal; selecting a unique sponsor id and password; selecting a trivia game to sponsor; paying an entry fee; and providing said central server with information relating to said sponsor's products and/or services for use in said trivia game.

A method of participating in an Internet game-based advertising system according to the invention comprises communicating with said central server; selecting a unique user id and password; providing information about said user to said central server; selecting a trivia game in which to participate; prior to commencement of said trivia game, receiving an identification of a list of sponsors of a game and of means of linking to information about said sponsors' products and/or services; researching said sponsors' products and/or services by linking to said information; at a pre-determined time for the commencement of said game, receiving an identification of questions based on the products and/or services of said sponsors, responding to said questions; and after the completion of said game receiving an identification of the winner of said game.

In another aspect, the invention comprises a central server configured as a host for an Internet trivia game in which said game comprises questions regarding the products and/or services of at least one game sponsor and in which a plurality of users compete simultaneously in order to win prizes by answering said questions using information obtained about said sponsor's products and/or services prior to commencement of said game using a list of game sponsors provided a pre-determined time before said commencement.

In yet another aspect, the invention comprises a game terminal configured to play an Internet trivia game in which said game comprises questions regarding the products and/or services of sponsors of said game and in which users compete simultaneously in real-time in order to win prizes by answering said questions using information about said sponsors' products and/or services obtained prior to commencement of said game using a list of game sponsors provided a pre-determined time before said commencement.

In yet another aspect, the invention comprises a sponsor terminal configured so that a sponsor's web site is linked to the central server described above.

In another aspect of the invention, the game is played simultaneously by the users in real-time and the commencement of the game is at a designated start time.

In another aspect, there is a pre-determined interval between the steps of identifying the sponsor to the users and the commencement of the game.

In another aspect, the information about said users includes either demographic or geographic information about said users, or both.

In another aspect, said users are allowed to participate in said trivia game based on either demographic or geographic information, or both.

In another aspect, said information relating to said sponsor's products and/or services includes questions and answers based on said products and/or services.

In another aspect, information about said sponsor's products and/or services with which to answer the game questions is located on said sponsor's web site.

In another aspect, information about said sponsor's products and/or services with which to answer the game questions is in advertising about said sponsor's products and/or services.

In another aspect, said sponsor provides information enabling a link to be established from said central server to said sponsor's web site.

In another aspect, prior to commencement of said trivia game, said users link to said sponsor's web site.

Further aspects of the invention will be appreciated by reference to the description of embodiments of the invention below and to the claims.

### BRIEF DESCRIPTION OF THE DRAWINGS

The invention is now described by way of examples with reference to the accompanying drawings, in which:

FIG. 1 illustrates a central server, a plurality of game terminals and a plurality of sponsor terminals connected by a network;

FIG. 2 illustrates a flow chart of one embodiment of a method for registering a sponsor;

FIG. 3 illustrates a flow chart of one embodiment of a method for a sponsor to register for a trivia game;

FIG. 4 illustrates a flow chart of one embodiment of a method for registering a user; and

FIG. 5 illustrates a flow chart of one embodiment of a method for playing the trivia game.

### DETAILED DESCRIPTION OF THE PREFERRED AND ALTERNATIVE EMBODIMENTS OF THE INVENTION

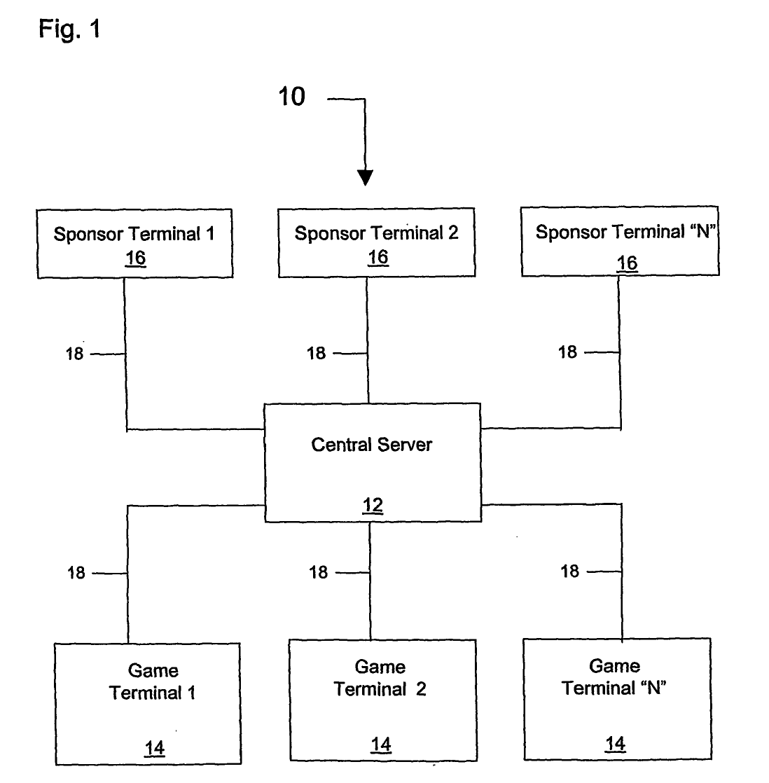

A preferred embodiment of an on-line Internet trivia game based advertising system 10 according to the invention is illustrated In FIG. 1. A central server 12 is connected to a plurality of remote game terminals 14 and to sponsor terminals 16. The central server 12 may be a data processing unit, such as a desktop computer, a server, or the like. The game terminal 14 may be a personal computer, a video game console with networking capabilities, or any electronic device that can connect with the central server and is capable of running the game. The sponsor terminal 16 is also a computer, or any electronic device that can connect with the central server. Connection between the central server 12 and the game terminals 14 and the sponsor terminals 16 may be made by way of a fixed line connection such as the Internet 18, or by a wireless telecommunication network or the like.

The central server 12 acts as the game controller and has software and/or hardware that allows it to carry out this function. The game terminals 14 are initially anticipated to be home computers connected to central server 12 via the Internet. The sponsor terminals 16 are also anticipated to be computers from which sponsors may connect with the central server.

The sponsors are parties, most likely businesses, that wish to advertise their respective services and products by way of the system. Businesses interested in making use of this system pay to be listed as a sponsor of a given game. When a business registers to use the system it will be given a unique user id and password. If the business wishes to advertise its products and/or services by becoming a sponsor of a game, it first signs in using its unique sponsor id and password. The sponsor is then provided options as to the games that are available to it to sponsor. After providing certain required information to sponsor a given game, the sponsor may sign out.

Users make use of the game terminals 14 to connect to the central server 12 in order to play an online game in which a respective user's success is dependent on that user's knowledge of the products and services of the sponsors of the game. Users are attracted to the game by the opportunity to win prizes. The prizes for a given game will take the form of money or products obtained from the sponsors of that game. Information contained on the sponsors' respective web sites located on their sponsor terminals provides the subject matter for the game.

The game questions are based on information located on the game sponsors' respective web sites. It is anticipated that the game questions will take the form of multiple choice, such that the users are presented with a question and several answers, one of which is correct. It is also anticipated that the questions and answers may be presented to the users in the form of text, graphics, audio and/or visual media or some combination thereof.

Individuals interested in taking part in a game are able to register as users. Once registered, users will be provided options with respect to, and may select, games in which to take part. Games are listed well ahead of the actual date and time for the game. For each game available to a user, the sponsors of the game are listed. Links to the respective sponsor web sites are available to the user so that the user can review the contents of the respective sponsors' web sites prior to commencement of the game. In this way, the users become familiar with the products and services of the various sponsors of the game.

The game is preferably played live during a specific time slot using a real-time game format. Prior to the start of a game, the user signs in to the central server. All users signed in to play a specific game receive a given question simultaneously. Questions are posed one at a time to the users with respect to the information contained on the game sponsors' web sites. The time available to answer each question is limited and is controlled by the central server. A new question is not posed to the users until the time has run out to answer the current question. By asking all users the same questions at the same time, cheating is prevented. The time to answer each question is monitored and recorded and ideally will be quite short. The answers given are monitored and recorded. Incorrect answers are assigned a penalty and are monitored and recorded. The greatest number of correct answers provided in the shortest period of time wins the game.

It is anticipated that there will be different levels of game play. For example, one game may be locally based, with locally based users and with locally based sponsors. A second game may be provincially based, with provincially based users and sponsors. A third game may be nationally based, with nationally based users and sponsors. Further game types such as those based on specific demographics or geographical considerations are anticipated.

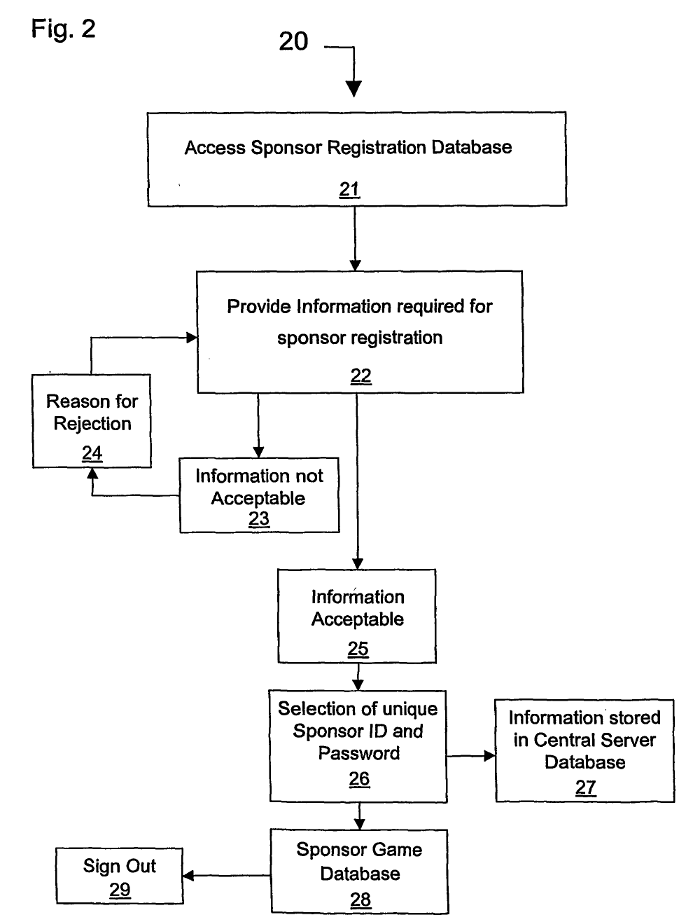

A preferred embodiment of the system will now be described in more detail. The preferred embodiment of the registration process for a sponsor 20 is illustrated in FIG. 2. After establishing a connection with the central server 12 by way of a sponsor terminal 16, the user accesses the sponsor registration database 21. The sponsor must complete a questionnaire and provide certain mandatory information 22, including contact and billing information. If the information provided is not acceptable 23, the central server notifies the sponsor of the reason for its rejection 24. If the information provided, and therefore the sponsor, is acceptable, the central server conveys its acceptance to the sponsor 25 and the sponsor is prompted to select a unique sponsor id and password 26. The information obtained from the sponsor, including its sponsor id and password is stored in the database of the central server 27 for retrieval whenever the sponsor signs in. The information provided by the sponsor will be used for the purposes of the game, but will otherwise be kept confidential. Once the sponsor has a unique sponsor id and password it may access the sponsor game database 28. Should it desire to, the sponsor may sign out of the sponsor game database 29.

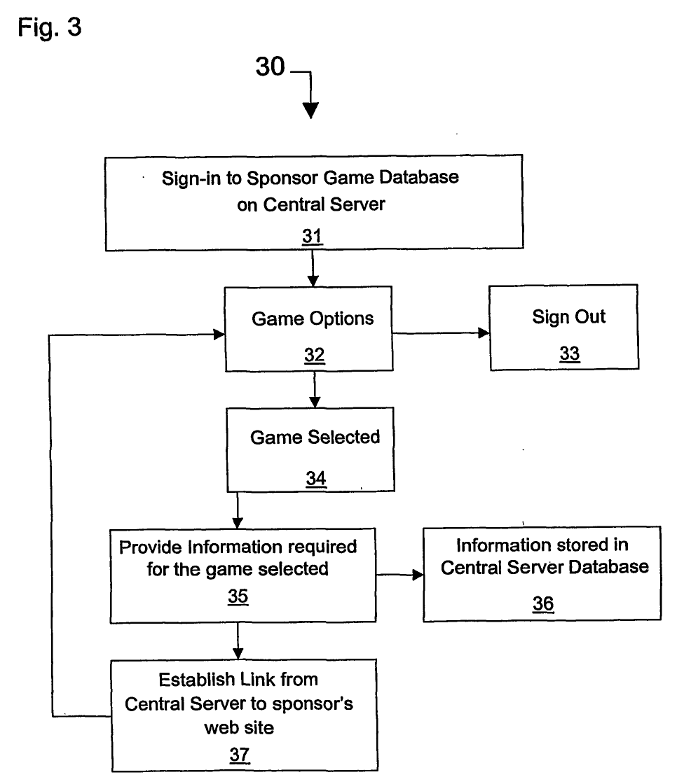

A preferred embodiment of the process for a sponsor's registration to sponsor a game 30 is illustrated in FIG. 3. Using its unique sponsor id and password, a sponsor signs in to the sponsor game database on the central server 31. Once the sponsor has signed in successfully, the central server provides the sponsor with game options 34. The game options for a given sponsor may be structured so as to take into account information about the sponsor previously obtained from the sponsor 22 and stored in the central server database 27. Information provided with the game options may include the costs and details associated with, and timing of, upcoming games. By reviewing the details associated with a game, the sponsor is able to determine whether the game will reach its target audience. If the sponsor does not wish to sponsor a game at this time, it may sign out 33. Alternatively, the sponsor may select a game that it wishes to sponsor 34. After the sponsor has selected the game it would like to sponsor, it must submit information required for the game to the central server 35. This information may include questions for use in the game and billing information. It is anticipated that the sponsor will be able to choose whether to submit a plurality of questions for use in the game or to have others design questions for it. The game questions that a sponsor provides are based on its products and services. The information with which to answer the questions provided by the sponsor can be found at the sponsor's web site. Preferably, the questions will be in the form of multiple choice questions with one right answer and multiple wrong answers. The information provided by the sponsor is stored in the central server database 36. The sponsor, on prompting by the central server, completes the necessary steps to establish a link from the central server to the sponsor's web site 37. This link may be established using referring uniform resource locator (URL) information. It is also contemplated that those sponsors that do not have a web site could simply provide advertising information to the central server which would be made available to users wishing to play the game(s) sponsored by those sponsors. After the sponsor has input all the required information to the central server, it is returned to the game options menu 32 where it may select another game to sponsor 34, or it may sign off of the system 33.

The central server, using the billing information provided by the sponsor 35, will bill the sponsor for the requested game. Billing options may include payment by credit card, through a corporate account, or by way of some other form of electronic account. It is also contemplated that invoices may be sent to sponsors for payment. Sponsors may also pay by way of products to be used as prizes.

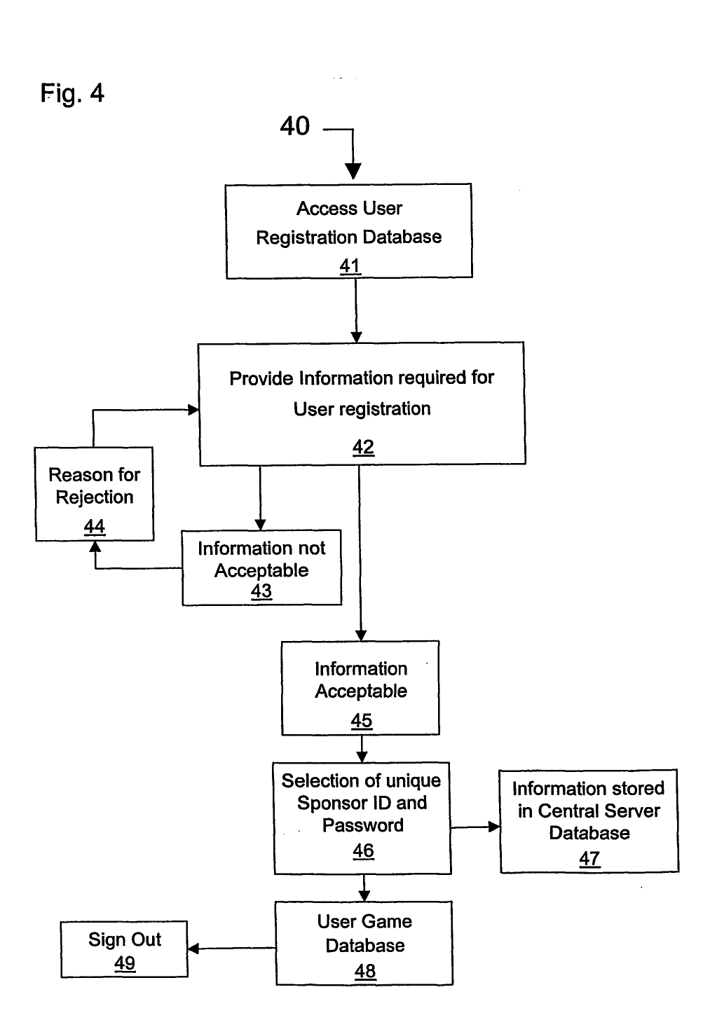

A preferred embodiment of the anticipated registration procedure for a user is illustrated in FIG. 4. After establishing a connection with the central server 12 by way of a game terminal 14, the user accesses the user registration database 41. The user must complete a questionnaire and provide certain mandatory information 42, which may include demographic and geographic information. The information provided by the user will be used for the purposes of the game, but will otherwise be kept confidential. If the information provided is not acceptable 43, the central server notifies the user of the reason for its rejection 44. If the information provided, and therefore the user, is acceptable, the central server conveys its acceptance to the user 45 and the user is prompted to select a unique user id and password 46. The information obtained from the user, including its user id and password is stored in the database of the central server 47 for retrieval whenever the user signs in. Once the user has a unique user id and password it may access the user game database 48. Should it desire to, the user may sign out of the user game database 49.

When a user signs on to the central server 12 using its unique user id and password, it will be provided with options as to the games available to it. The demographic and geographical information provided by the user 42, and stored in the central server database 47, may be used to determine the games available to the user. Information including the prizes and sponsors of the game and the date and time the game is to be played is listed for each game available to a user. This information is available well in advance of the scheduled start date of the game so that prior to the start of a given game the user is able to link to the various sponsor web sites or advertising information for the game they have chosen to take part in. This provides the user an opportunity to research the information upon which the game questions will be based and to learn about the various sponsors' products and services.

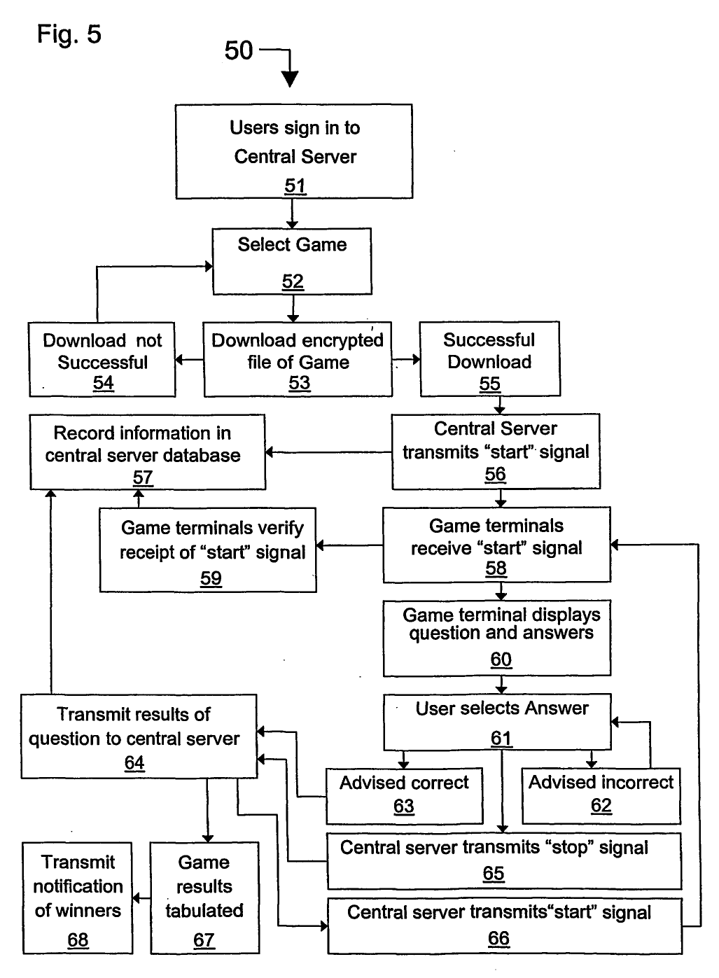

A preferred embodiment of the process for game play 50 is illustrated in FIG. 5. All users intending to take part in a game must access the central server 12 and sign in 51. Once signed in, a user must select the game in which they intend to participate 52. Before the game begins, each user's game terminal will communicate with the central server and download an encrypted file containing all of the questions and answers for the game 53. The files are encrypted in order to ensure no user learns what the questions and answers are ahead of time, thereby ensuring the fairness of the game. Once a user's game terminal has downloaded the encrypted file containing the questions and answers it will send a signal to the central server announcing that this has occurred 55. If the download is not successful, the user may select the game again 52 and repeat the download procedure 53. Once the download of the encrypted file is complete, the users must wait for the game to start. At the scheduled start time, the central server will broadcast a “start” signal 56. The game terminals will receive the start signal 58 and send a signal to the central server verifying the time of receipt of the start signal 59. The central server will record in its database 57 the time at which the start signal was sent to and received by each respective game terminal.

After a game terminal receives a “start” signal from the central server it will begin to display information for the user. The game terminal will decrypt a question and corresponding selection of answers and display them to the user 60. The user will review the question and possible answers and select the answer that the user feels is correct 61. If the user selects the wrong answer, it is advised it is incorrect 62 and provided there is time remaining in which to answer the question, is returned to the question to select an answer 61. If the user selects the correct answer, it is advised it is correct 63. The game terminal transmits the users results for the question 64 to the central server, including the time taken to correctly answer and the number of incorrect answers selected. After a prescribed period of time, the central server will broadcast a “stop” signal 65 to the game terminals. When the game terminals receive the “stop” signal all terminals that have not yet provided the central server with their results 64 will do so at that time. The results received by the central server for each user are time stamped and recorded into its database 57. After a set period of time following the issuance of the stop signal, the central server transmits another “start” signal 66 to the game terminals, thereby repeating the above process with a new question. This is repeated until all questions in a game have been completed. After a game is completed, the game results are tabulated 67 and a notification is transmitted by the central server to the users' game terminals notifying the users of the winners of the game 68. Should a game terminal for any reason fail to respond to any signals sent by the central server within a prescribed time, the game terminal, and therefore the user, will be dropped from the game.

It is anticipated that rather than sending encrypted files to all game terminals, that the central server will control all aspects of the game, including providing the questions and answers on a real-time basis.

Because the central server records all information about a given game, it is able to generate reports providing statistical information to the sponsors of the game. These reports could include the number of users taking part in a given game and the number of those users to answer a sponsor's question(s) correctly. By way of these statistics, a sponsor may be given an indication of the number of users that are aware of its products and/or services.

Although certain preferred embodiments of the present invention have been shown and described in detail, it should be understood that various changes and modifications may be made therein without departing from the scope of the appended claims.

What is claimed is:

1. An Internet game-based advertising system comprising a real-time trivia game in which at least one sponsor pays to provide questions about its products and/or services for use in said trivia game and wherein a plurality of users use a plurality of remote game terminals to compete simultaneously in said trivia game to win prizes by answering a plurality of said questions using information about said sponsor's products and/or services obtained prior to commencement of said trivia game using a list of game sponsors provided a pre-determined time before said commencement.

2. The system of claim 1 wherein said real-time trivia game is played through, and controlled by, a central server.

3. The system of claim 2 wherein said information is obtained from said sponsor's web site.

4. The system of claim 2 wherein said information is obtained from advertisements.

5. The system of claim 4 wherein said advertisements are accessed through said central server.

6. A method of controlling an Internet-based trivia game comprising:
designating at least one sponsor of said game;
authorizing a plurality of users to participate in said game;
prior to commencement of said game, identifying said sponsor to said users and enabling said users to link to information about said sponsor's products and/or services;
at the commencement of said game, communicating to said users questions based on said information;
designating among said users a winner of said game based on the correctness of, and the time to provide, the answers provided by each of the users.

7. The method of claim 6, wherein said game is played simultaneously by said users in real-time, and said commencement of said game being at a designated start time.

8. The method of claim 7, wherein there is a pre-determined interval between the steps of identifying said sponsor to said users and the commencement of said game

9. The method of claim 8, wherein said information is located on said sponsor's web site.

10. The method of claim 8, wherein said information is located in advertisements.

11. The method of claim 8 wherein said users are authorized to participate in said game based on demographic and/or geographic information.

12. The method of claim 9, wherein said link to said sponsor's web site is a referring uniform resource locator.

13. A method of hosting an Internet game-based advertising system in which a central server hosts a trivia game where at least one sponsor pays to provide questions about said sponsors products and/or services for use in said trivia game and wherein a plurality of users use a plurality of remote game terminals to compete simultaneously in said trivia game to win prizes by answering a plurality of said questions using information about said sponsor's products and/or services obtained prior to commencement of said trivia game, the method comprising the steps of:
receiving a communication from said sponsor;
uniquely identifying said sponsor;
collecting and storing information about said sponsor;
allowing said sponsor to sponsor a game upon payment of an entry fee by the sponsor;
accepting from said sponsor questions and answers relating to said sponsor's products and/or services for use in said trivia game;
receiving a communication from each of said users;
uniquely identifying each of said users;
collecting and storing information about each of said users;
allowing said users to participate in said trivia game;
prior to said trivia game, identifying said sponsor to said users and enabling said users to link it information about said sponsor's products and/or services;
at the commencement of said game, communicating to said users questions based on said information about said sponsor's products and/or services;
designating a winner of said game based on the correctness of and the time to provide, the answers provided by the users.

14. The method of claim 13, wherein said game is played simultaneously by said users in real-time, and said commencement of said game being at a designated time.

15. The method of claim 14, wherein there is a pre-determined interval between the steps of identifying said sponsor to said users and the commencement of said game.

16. The method of claim 15, wherein said information about said sponsor's products and/or services is located on said sponsor's web site.

17. The method of claim 15, wherein said information about said sponsor's products and/or services is located in advertisements.

18. The method of claim 16, wherein said information about said users includes either demographic or geographic information about said users, or both.

19. The method of claim 18, wherein said users are allowed to participate in said trivia game based on either demographic or geographic information, or both.

20. The method of claim 16, wherein said link to said sponsor's web site is a referring uniform resource locator.

21. A method of sponsoring an Internet game-based advertising system in which a central server hosts a trivia game where at least one sponsor pays to provide questions about its products and/or services for use in said trivia game and wherein a plurality of users use a plurality of remote game terminals to compete simultaneously in said trivia game to win prizes by answering a plurality of said questions using information about said sponsor's products and/or services obtained prior to commencement of said trivia game, the method comprising the steps of:
communicating with said central server by way of a sponsor terminal;
selecting a unique sponsor id and password;
selecting a trivia game to sponsor;
paying an entry fee;
providing said central server with information relating to said sponsor's products and/or services for use in said trivia game.

22. The method of claim 21, wherein said information relating to said sponsor's products and/or services includes questions and answers based on said products and/or services.

23. The method of claim 22, wherein information about said sponsor's products and/or services is located on said sponsor's web site.

24. The method of claim 22, wherein said information also includes advertising information about said sponsor's products and/or services.

25. The method of claim 23, wherein said sponsor provides information enabling a link to be established from said central server to said sponsor's web site.

26. The method of claim 25, wherein prior to commencement of said trivia game, said users link to said sponsor's web site.

27. A method of participating in an Internet game-based advertising system in which a central server hosts a trivia game where at least one sponsor pays to provide questions about its products and/or services for use in said trivia game and wherein a plurality of users use a plurality of remote game terminals to compete simultaneously in said trivia game to win prizes by answering a plurality of said questions using information obtained about said sponsor's products and/or services prior to commencement of said trivia game, the method comprising the steps of:
communicating with said central server;
selecting a unique user id and password;
providing information about said user to said central server;
selecting a trivia game in which to participate;
prior to commencement of said trivia game, receiving an identification of a list of sponsors of a game and of means of linking to information about said sponsors' products and/or services;
researching said sponsors' products and/or services by linking to said information;
at a pre-determined time for the commencement of said game, receiving an identification of questions based on the products and/or services of said sponsors,
responding to said questions;
after the completion of said game receiving an identification of the winner of said game.

28. The method of claim 27, wherein said game is played simultaneously by said users in real-time, and said commencement of said game being at a designated start time.

29. The method of claim 28, wherein there is a pre-determined interval between the steps of said sponsors being identified and the commencement of said game.

30. The method of claim 29, wherein said information about said sponsor's products and/or services is located on said sponsor's web site and/or is located in advertisements.

31. The method of claim 30, wherein said information about said users includes either demographic or geographic information about said users, or both.

32. The method of claim 31, wherein said users are allowed to participate in said trivia game based on either demographic or geographic information, or both.

33. The method of claim 30, wherein said means of linking to said sponsor's web site is a referring uniform resource locator.

34. A central server configured as a host for an Internet trivia game in which said game comprises questions regarding the products and/or services of at least one game sponsor and in which a plurality of users compete simultaneously in order to win prizes by answering said questions using information obtained about said sponsor's products and/or services prior to commencement of said game using a list of game sponsors provided a pre-determined time before said commencement.

35. A central server of claim 34, wherein said information is located on said sponsor's web site.

36. A central server of claim 35, wherein said users are enabled to link from said central server to said sponsor's web site.

37. A central server of claim 36, wherein said link is achieved by using referring uniform resource locator information regarding said sponsor's web site.

38. A game terminal configured to play an Internet trivia game in which said game comprises questions regarding the products and/or services of sponsors of said game and in which users compete simultaneously in real-time in order to win prizes by answering said questions using information about said sponsors' products and/or services obtained prior to commencement of said game using a list of game sponsors provided a pre-determined time before said commencement.

39. A sponsor terminal configured so that a sponsor's web site is linked to the central server of claim 36.
